(19) United States
(12) Patent Application Publication
(10) Pub. No.: US 2026/0052052 A1
(43) Pub. Date: Feb. 19, 2026

(54) INTERLEAVED DFT PHASE ROTATED PERMUTATION BASED FDMA

(71) Applicant: Samsung Electronics Co., Ltd., Suwon-si (KR)

(72) Inventors: Nuwan S. Ferdinand, Stittsville (CA); Joonyoung Cho, Portland, OR (US)

(21) Appl. No.: 19/041,795

(22) Filed: Jan. 30, 2025

Related U.S. Application Data
(60) Provisional application No. 63/683,960, filed on Aug. 16, 2024.

(51) Int. Cl. H04L 27/26; H04L 1/00

(52) U.S. Cl. CPC H04L 27/265; H04L 1/0071

(57) ABSTRACT

An electronic device includes a processor. The processor is configured to convert a modulation symbol sequence of length MK into interleaved discrete Fourier transform phase rotated permutation based frequency division multiple access (DFT-p-FDMA) symbols. The electronic device also includes a transceiver operatively coupled to the processor. The transceiver is configured to transmit the interleaved DFT-p-FDMA symbols.

### CROSS-REFERENCE TO RELATED APPLICATION(S) AND CLAIM OF PRIORITY

This application claims priority under 35 U.S.C. § 119(e) to U.S. Provisional Patent Application No. 63/683,960 filed on Aug. 16, 2024. The above-identified provisional patent application is hereby incorporated by reference in its entirety.

### TECHNICAL FIELD

This disclosure relates generally to wireless networks. More specifically, this disclosure relates to interleaved discrete Fourier transform (DFT) phase rotated permutation based frequency division multiple access (FDMA).

### BACKGROUND

The demand of wireless data traffic is rapidly increasing due to the growing popularity among consumers and businesses of smart phones and other mobile data devices, such as tablets, “note pad” computers, net books, eBook readers, and machine type of devices. In order to meet the high growth in mobile data traffic and support new applications and deployments, improvements in radio interface efficiency and coverage is of paramount importance.

To meet the demand for wireless data traffic having increased since deployment of 4G communication systems, and to enable various vertical applications, 5G communication systems have been developed and are currently being deployed. The enablers for the 5G/NR mobile communications include massive antenna technologies, from legacy cellular frequency bands up to high frequencies, to provide beamforming gain and support increased capacity, new waveform (e.g., a new radio access technology [RAT]) to flexibly accommodate various services/applications with different requirements, new multiple access schemes to support massive connections, and so on.

### SUMMARY

This disclosure provides apparatuses and methods for interleaved DFT phase rotated permutation based FDMA.

In one embodiment, an electronic device is provided. The electronic device includes a processor. The processor is configured to convert a modulation symbol sequence of length MK into interleaved discrete Fourier transform phase rotated permutation based frequency division multiple access (DFT-p-FDMA) symbols. The electronic device also includes a transceiver operatively coupled to the processor. The transceiver is configured to transmit the interleaved DFT-p-FDMA symbols.

In another embodiment, a method of operating an electronic device is provided. The method includes converting a modulation symbol sequence of length MK into interleaved DFT-p-FDMA symbols. The method also includes transmitting the interleaved DFT-p-FDMA symbols.

In yet another embodiment, a non-transitory computer readable medium embodying a computer program is provided. The computer program includes program code, that when executed by a processor of a device, causes the device to convert a modulation symbol sequence of length MK into interleaved DFT-p-FDMA symbols, and transmit the interleaved DFT-p-FDMA symbols.

Other technical features may be readily apparent to one skilled in the art from the following figures, descriptions, and claims.

Before undertaking the DETAILED DESCRIPTION below, it may be advantageous to set forth definitions of certain words and phrases used throughout this patent document. The term “couple” and its derivatives refer to any direct or indirect communication between two or more elements, whether or not those elements are in physical contact with one another. The terms “transmit,” “receive,” and “communicate,” as well as derivatives thereof, encompass both direct and indirect communication. The terms “include” and “comprise,” as well as derivatives thereof, mean inclusion without limitation. The term “or” is inclusive, meaning and/or. The phrase “associated with,” as well as derivatives thereof, means to include, be included within, interconnect with, contain, be contained within, connect to or with, couple to or with, be communicable with, cooperate with, interleave, juxtapose, be proximate to, be bound to or with, have, have a property of, have a relationship to or with, or the like. The term “controller” means any device, system or part thereof that controls at least one operation. Such a controller may be implemented in hardware or a combination of hardware and software and/or firmware. The functionality associated with any particular controller may be centralized or distributed, whether locally or remotely. The phrase “at least one of,” when used with a list of items, means that different combinations of one or more of the listed items may be used, and only one item in the list may be needed. For example, “at least one of: A, B, and C” includes any of the following combinations: A, B, C, A and B, A and C, B and C, and A and B and C.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for other certain words and phrases are provided throughout this patent document. Those of ordinary skill in the art should understand that in many if not most instances, such definitions apply to prior as well as future uses of such defined words and phrases.

### BRIEF DESCRIPTION OF THE DRAWINGS

For a more complete understanding of this disclosure and its advantages, reference is now made to the following description, taken in conjunction with the accompanying drawings, in which:

FIG. 1 illustrates an example wireless network according to embodiments of the present disclosure;

FIGS. 2A and 2B illustrate example wireless transmit and receive paths according to embodiments of the present disclosure;

FIG. 3A illustrates an example UE according to embodiments of the present disclosure;

FIG. 3B illustrates an example gNB according to embodiments of the present disclosure;

FIG. 4 illustrates an example transmitter according to embodiments of the present disclosure;

FIG. 5 illustrates another example transmitter according to embodiments of the present disclosure;

FIG. 6 illustrates an example procedure for operation of a transmitter according to embodiments of the present disclosure;

FIG. 7 illustrates an example of interleaving according to embodiments of the present disclosure;

FIG. 8 illustrates an example of row allocation according to embodiments of the present disclosure;

FIG. 9 illustrates an example interleaving operation according to embodiments of the present disclosure;

FIG. 10 illustrates another example of interleaving according to embodiments of the present disclosure;

FIG. 11 illustrates another example interleaving operation according to embodiments of the present disclosure;

FIG. 12 illustrates an example procedure for downlink signaling according to embodiments of the present disclosure;

FIG. 13 illustrates an example procedure for uplink signaling according to embodiments of the present disclosure; and

FIG. 14 illustrates an example method for interleaved DFT phase rotated permutation based FDMA according to embodiments of the present disclosure.

### DETAILED DESCRIPTION

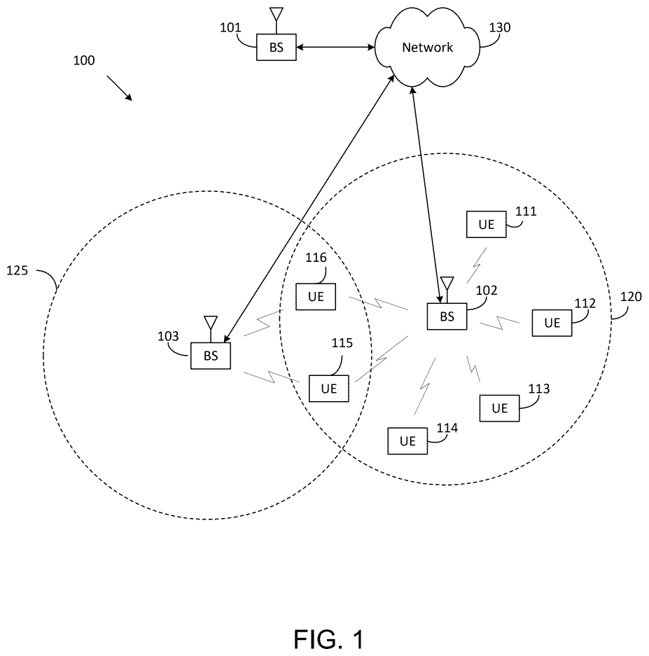

FIGS. 1 through 14, discussed below, and the various embodiments used to describe the principles of this disclosure in this patent document are by way of illustration only and should not be construed in any way to limit the scope of the disclosure. Those skilled in the art will understand that the principles of this disclosure may be implemented in any suitably arranged wireless communication system.

To meet the demand for wireless data traffic having increased since deployment of 4G communication systems and to enable various vertical applications, 5G/NR communication systems have been developed and are currently being deployed. The 5G/NR communication system is considered to be implemented in higher frequency (mm Wave) bands, e.g., 28 GHz or 60 GHz bands, so as to accomplish higher data rates or in lower frequency bands, such as 6 GHz, to enable robust coverage and mobility support. To decrease propagation loss of the radio waves and increase the transmission distance, the beamforming, massive multiple-input multiple-output (MIMO), full dimensional MIMO (FD-MIMO), array antenna, an analog beam forming, large scale antenna techniques are discussed in 5G/NR communication systems.

In addition, in 5G/NR communication systems, development for system network improvement is under way based on advanced small cells, cloud radio access networks (RANs), ultra-dense networks, device-to-device (D2D) communication, wireless backhaul, moving network, cooperative communication, coordinated multi-points (COMP), reception-end interference cancelation and the like.

The discussion of 5G systems and frequency bands associated therewith is for reference as certain embodiments of the present disclosure may be implemented in 5G systems. However, the present disclosure is not limited to 5G systems or the frequency bands associated therewith, and embodiments of the present disclosure may be utilized in connection with any frequency band. For example, aspects of the present disclosure may also be applied to deployment of 5G communication systems, 6G or even later releases which may use terahertz (THz) bands.

FIGS. 1-3B below describe various embodiments implemented in wireless communications systems and with the use of orthogonal frequency division multiplexing (OFDM) or orthogonal frequency division multiple access (OFDMA) communication techniques. The descriptions of FIGS. 1-3B are not meant to imply physical or architectural limitations to the manner in which different embodiments may be implemented. Different embodiments of the present disclosure may be implemented in any suitably arranged communications system.

FIG. 1 illustrates an example wireless network 100 according to embodiments of the present disclosure. The embodiment of the wireless network shown in FIG. 1 is for illustration only. Other embodiments of the wireless network 100 could be used without departing from the scope of this disclosure.

As shown in FIG. 1, the wireless network includes a gNB 101 (e.g., base station, BS), a gNB 102, and a gNB 103. The gNB 101 communicates with the gNB 102 and the gNB 103. The gNB 101 also communicates with at least one network 130, such as the Internet, a proprietary Internet Protocol (IP) network, or other data network.

The gNB 102 provides wireless broadband access to the network 130 for a first plurality of user equipments (UEs) within a coverage area 120 of the gNB 102. The first plurality of UEs includes a UE 111, which may be located in a small business; a UE 112, which may be located in an enterprise; a UE 113, which may be a WiFi hotspot; a UE 114, which may be located in a first residence; a UE 115, which may be located in a second residence; and a UE 116, which may be a mobile device, such as a cell phone, a wireless laptop, a wireless PDA, or the like. The gNB 103 provides wireless broadband access to the network 130 for a second plurality of UEs within a coverage area 125 of the gNB 103. The second plurality of UEs includes the UE 115 and the UE 116. In some embodiments, one or more of the gNBs 101-103 may communicate with each other and with the UEs 111-116 using 5G/NR, long term evolution (LTE), long term evolution-advanced (LTE-A), WiMAX, WiFi, or other wireless communication techniques.

Depending on the network type, the term “base station” or “BS” can refer to any component (or collection of components) configured to provide wireless access to a network, such as transmit point (TP), transmit-receive point (TRP), an enhanced base station (eNodeB or eNB), a 5G/NR base station (gNB), a macrocell, a femtocell, a WiFi access point (AP), or other wirelessly enabled devices. Base stations may provide wireless access in accordance with one or more wireless communication protocols, e.g., 5G/NR 3^{rd} generation partnership project (3GPP) NR, long term evolution (LTE), LTE advanced (LTE-A), high speed packet access (HSPA), Wi-Fi 802.11a/b/g/n/ac, etc. For the sake of convenience, the terms “BS” and “TRP” are used interchangeably in this patent document to refer to network infrastructure components that provide wireless access to remote terminals. Also, depending on the network type, the term “user equipment” or “UE” can refer to any component such as “mobile station,” “subscriber station,” “remote terminal,” “wireless terminal,” “receive point,” or “user device.” For the sake of convenience, the terms “user equipment” and “UE” are used in this patent document to refer to remote wireless equipment that wirelessly accesses a BS, whether the UE is a mobile device (such as a mobile telephone or smartphone) or is normally considered a stationary device (such as a desktop computer or vending machine).

Dotted lines show the approximate extents of the coverage areas 120 and 125, which are shown as approximately circular for the purposes of illustration and explanation only. It should be clearly understood that the coverage areas associated with gNBs, such as the coverage areas 120 and 125, may have other shapes, including irregular shapes, depending upon the configuration of the gNBs and variations in the radio environment associated with natural and man-made obstructions.

As described in more detail below, one or more of the UEs 111-116 include circuitry, programing, or a combination thereof, for interleaved DFT phase rotated permutation based FDMA. In certain embodiments, one or more of the gNBs 101-103 includes circuitry, programing, or a combination thereof, to support interleaved DFT phase rotated permutation based FDMA in a wireless communication system.

Although FIG. 1 illustrates one example of a wireless network, various changes may be made to FIG. 1. For example, the wireless network could include any number of gNBs and any number of UEs in any suitable arrangement. Also, the gNB 101 could communicate directly with any number of UEs and provide those UEs with wireless broadband access to the network 130. Similarly, each gNB 102-103 could communicate directly with the network 130 and provide UEs with direct wireless broadband access to the network 130. Further, the gNBs 101, 102, and/or 103 could provide access to other or additional external networks, such as external telephone networks or other types of data networks.

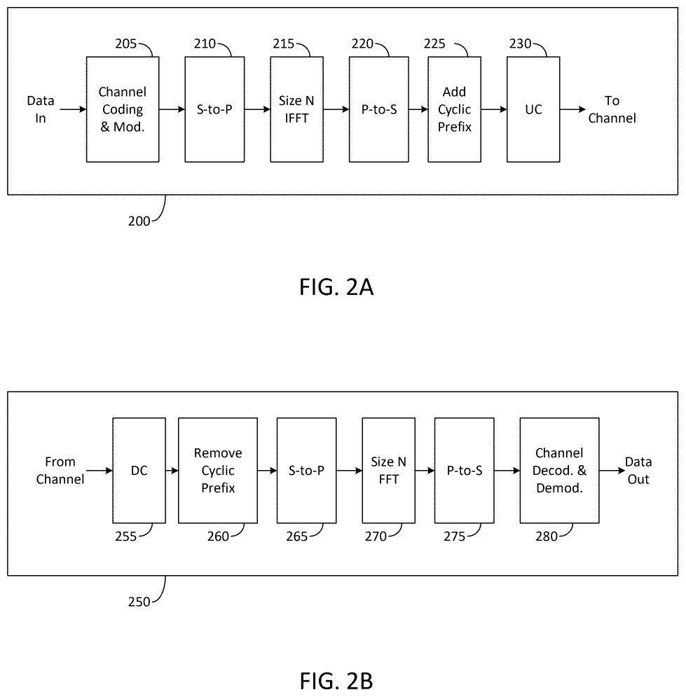

FIGS. 2A and 2B illustrate example wireless transmit and receive paths according to embodiments of the present disclosure. In the following description, a transmit path 200 may be described as being implemented in a gNB (such as gNB 102), while a receive path 250 may be described as being implemented in a UE (such as UE 116). However, it will be understood that the receive path 250 can be implemented in a gNB and that the transmit path 200 can be implemented in a UE. In some embodiments, the transmit path 200 and/or the receive path 250 is configured to implement and/or support interleaved DFT phase rotated permutation based FDMA as described in embodiments of the present disclosure.

The transmit path 200 includes a channel coding and modulation block 205, a serial-to-parallel (S-to-P) block 210, a size N Inverse Fast Fourier Transform (IFFT) block 215, a parallel-to-serial (P-to-S) block 220, an add cyclic prefix block 225, and an up-converter (UC) 230. The receive path 250 includes a down-converter (DC) 255, a remove cyclic prefix block 260, a serial-to-parallel (S-to-P) block 265, a size N Fast Fourier Transform (FFT) block 270, a parallel-to-serial (P-to-S) block 275, and a channel decoding and demodulation block 280.

In the transmit path 200, the channel coding and modulation block 205 receives a set of information bits, applies coding (such as a low-density parity check (LDPC) coding), and modulates the input bits (such as with Quadrature Phase Shift Keying (QPSK) or Quadrature Amplitude Modulation (QAM)) to generate a sequence of frequency-domain modulation symbols. The serial-to-parallel block 210 converts (such as de-multiplexes) the serial modulated symbols to parallel data in order to generate N parallel symbol streams, where N is the IFFT/FFT size used in the gNB 102 and the UE 116. The size N IFFT block 215 performs an IFFT operation on the N parallel symbol streams to generate time-domain output signals. The parallel-to-serial block 220 converts (such as multiplexes) the parallel time-domain output symbols from the size N IFFT block 215 in order to generate a serial time-domain signal. The add cyclic prefix block 225 inserts a cyclic prefix to the time-domain signal. The up-converter 230 modulates (such as up-converts) the output of the add cyclic prefix block 225 to an RF frequency for transmission via a wireless channel. The signal may also be filtered at baseband before conversion to the RF frequency.

A transmitted RF signal from the gNB 102 arrives at the UE 116 after passing through the wireless channel, and reverse operations to those at the gNB 102 are performed at the UE 116. The down-converter 255 down-converts the received signal to a baseband frequency, and the remove cyclic prefix block 260 removes the cyclic prefix to generate a serial time-domain baseband signal. The serial-to-parallel block 265 converts the time-domain baseband signal to parallel time domain signals. The size N FFT block 270 performs an FFT algorithm to generate N parallel frequency-domain signals. The parallel-to-serial block 275 converts the parallel frequency-domain signals to a sequence of modulated data symbols. The channel decoding and demodulation block 280 demodulates and decodes the modulated symbols to recover the original input data stream.

Each of the gNBs 101-103 may implement a transmit path 200 that is analogous to transmitting in the downlink to UEs 111-116 and may implement a receive path 250 that is analogous to receiving in the uplink from UEs 111-116. Similarly, each of UEs 111-116 may implement a transmit path 200 for transmitting in the uplink to gNBs 101-103 and may implement a receive path 250 for receiving in the downlink from gNBs 101-103.

Each of the components in FIGS. 2A and 2B can be implemented using only hardware or using a combination of hardware and software/firmware. As a particular example, at least some of the components in FIGS. 2A and 2B may be implemented in software, while other components may be implemented by configurable hardware or a mixture of software and configurable hardware. For instance, the FFT block 270 and the IFFT block 215 may be implemented as configurable software algorithms, where the value of size N may be modified according to the implementation.

Furthermore, although described as using FFT and IFFT, this is by way of illustration only and should not be construed to limit the scope of this disclosure. Other types of transforms, such as Discrete Fourier Transform (DFT) and Inverse Discrete Fourier Transform (IDFT) functions, can be used. It will be appreciated that the value of the variable N may be any integer number (such as 1, 2, 3, 4, or the like) for DFT and IDFT functions, while the value of the variable N may be any integer number that is a power of two (such as 1, 2, 4, 8, 16, or the like) for FFT and IFFT functions.

Although FIGS. 2A and 2B illustrate examples of wireless transmit and receive paths, various changes may be made to FIGS. 2A and 2B. For example, various components in FIGS. 2A and 2B can be combined, further subdivided, or omitted and additional components can be added according to particular needs. Also, FIGS. 2A and 2B are meant to illustrate examples of the types of transmit and receive paths that can be used in a wireless network. Any other suitable architectures can be used to support wireless communications in a wireless network.

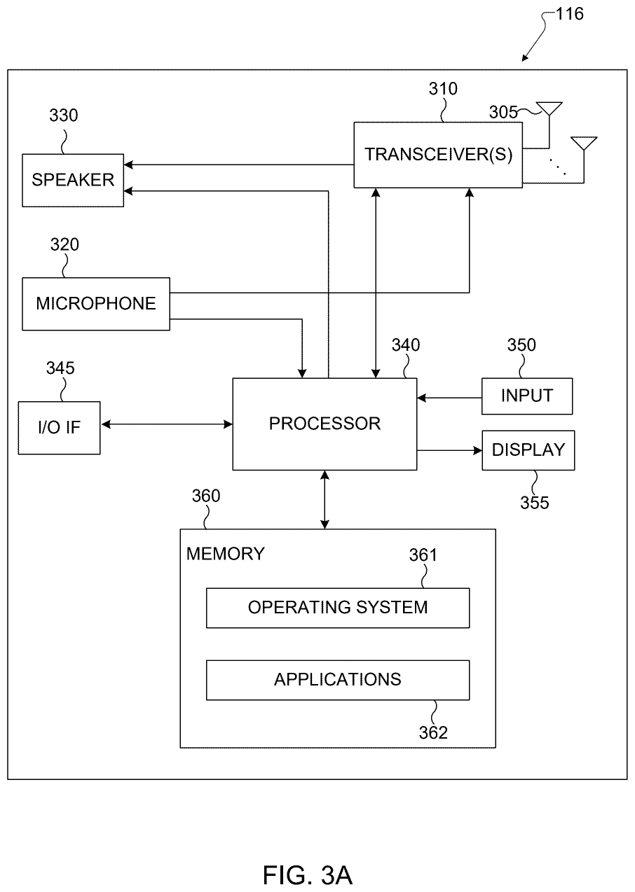

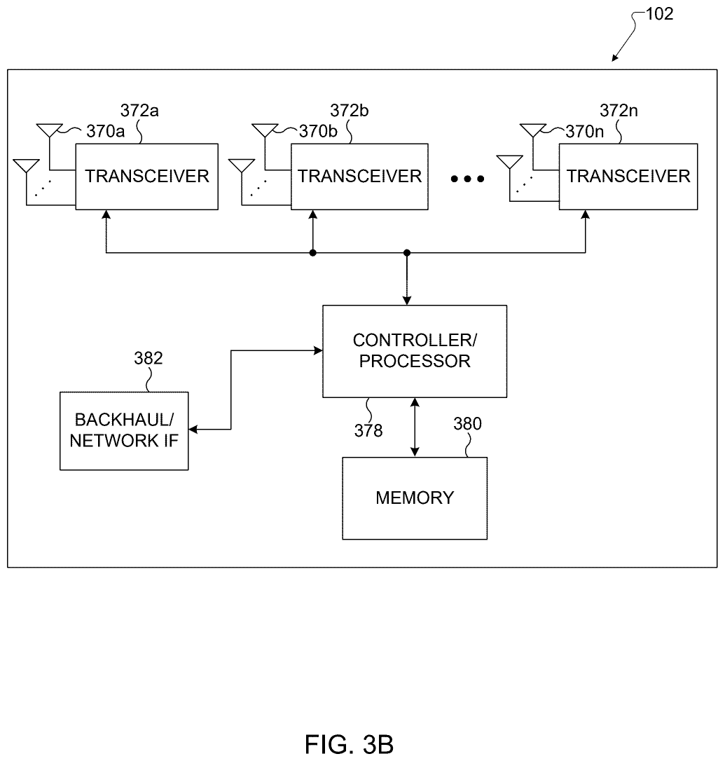

FIG. 3A illustrates an example UE 116 according to embodiments of the present disclosure. The embodiment of the UE 116 illustrated in FIG. 3A is for illustration only, and the UEs 111-115 of FIG. 1 could have the same or similar configuration. However, UEs come in a wide variety of configurations, and FIG. 3A does not limit the scope of this disclosure to any particular implementation of a UE.

As shown in FIG. 3A, the UE 116 includes antenna(s) 305, a transceiver(s) 310, and a microphone 320. The UE 116 also includes a speaker 330, a processor 340, an input/output (I/O) interface (IF) 345, an input 350, a display 355, and a memory 360. The memory 360 includes an operating system (OS) 361 and one or more applications 362.

The transceiver(s) 310 receives from the antenna 305, an incoming RF signal transmitted by a gNB of the network 100. The transceiver(s) 310 down-converts the incoming RF signal to generate an intermediate frequency (IF) or baseband signal. The IF or baseband signal is processed by RX processing circuitry in the transceiver(s) 310 and/or processor 340, which generates a processed baseband signal by filtering, decoding, and/or digitizing the baseband or IF signal. The RX processing circuitry sends the processed baseband signal to the speaker 330 (such as for voice data) or is processed by the processor 340 (such as for web browsing data).

TX processing circuitry in the transceiver(s) 310 and/or processor 340 receives analog or digital voice data from the microphone 320 or other outgoing baseband data (such as web data, e-mail, or interactive video game data) from the processor 340. The TX processing circuitry encodes, multiplexes, and/or digitizes the outgoing baseband data to generate a processed baseband or IF signal. The transceiver(s) 310 up-converts the baseband or IF signal to an RF signal that is transmitted via the antenna(s) 305.

The processor 340 can include one or more processors or other processing devices and execute the OS 361 stored in the memory 360 in order to control the overall operation of the UE 116. For example, the processor 340 could control the reception of DL channel signals and the transmission of UL channel signals by the transceiver(s) 310 in accordance with well-known principles. In some embodiments, the processor 340 includes at least one microprocessor or microcontroller.

The processor 340 is also capable of executing other processes and programs resident in the memory 360, for example, processes for interleaved DFT phase rotated permutation based FDMA as discussed in greater detail below. The processor 340 can move data into or out of the memory 360 as required by an executing process. In some embodiments, the processor 340 is configured to execute the applications 362 based on the OS 361 or in response to signals received from gNBs or an operator. The processor 340 is also coupled to the I/O interface 345, which provides the UE 116 with the ability to connect to other devices, such as laptop computers and handheld computers. The I/O interface 345 is the communication path between these accessories and the processor 340.

The processor 340 is also coupled to the input 350, which includes for example, a touchscreen, keypad, etc., and the display 355. The operator of the UE 116 can use the input 350 to enter data into the UE 116. The display 355 may be a liquid crystal display, light emitting diode display, or other display capable of rendering text and/or at least limited graphics, such as from web sites.

The memory 360 is coupled to the processor 340. Part of the memory 360 could include a random-access memory (RAM), and another part of the memory 360 could include a Flash memory or other read-only memory (ROM).

Although FIG. 3A illustrates one example of UE 116, various changes may be made to FIG. 3A. For example, various components in FIG. 3A could be combined, further subdivided, or omitted and additional components could be added according to particular needs. As a particular example, the processor 340 could be divided into multiple processors, such as one or more central processing units (CPUs) and one or more graphics processing units (GPUS). In another example, the transceiver(s) 310 may include any number of transceivers and signal processing chains and may be connected to any number of antennas. Also, while FIG. 3A illustrates the UE 116 configured as a mobile telephone or smartphone, UEs could be configured to operate as other types of mobile or stationary devices.

FIG. 3B illustrates an example gNB 102 according to embodiments of the present disclosure. The embodiment of the gNB 102 illustrated in FIG. 3B is for illustration only, and the gNBs 101 and 103 of FIG. 1 could have the same or similar configuration. However, gNBs come in a wide variety of configurations, and FIG. 3B does not limit the scope of this disclosure to any particular implementation of a gNB.

As shown in FIG. 3B, the gNB 102 includes multiple antennas 370a-370n, multiple transceivers 372a-372n, a controller/processor 378, a memory 380, and a backhaul or network interface 382.

The transceivers 372a-372n receive, from the antennas 370a-370n, incoming RF signals, such as signals transmitted by UEs in the network 100. The transceivers 372a-372n down-convert the incoming RF signals to generate IF or baseband signals. The IF or baseband signals are processed by receive (RX) processing circuitry in the transceivers 372a-372n and/or controller/processor 378, which generates processed baseband signals by filtering, decoding, and/or digitizing the baseband or IF signals. The controller/processor 378 may further process the baseband signals.

Transmit (TX) processing circuitry in the transceivers 372a-372n and/or controller/processor 378 receives analog or digital data (such as voice data, web data, e-mail, or interactive video game data) from the controller/processor 378. The TX processing circuitry encodes, multiplexes, and/or digitizes the outgoing baseband data to generate processed baseband or IF signals. The transceivers 372a-372n up-converts the baseband or IF signals to RF signals that are transmitted via the antennas 370a-370n.

The controller/processor 378 can include one or more processors or other processing devices that control the overall operation of the gNB 102. For example, the controller/processor 378 could control the reception of uplink (UL) channel signals and the transmission of downlink (DL) channel signals by the transceivers 372a-372n in accordance with well-known principles. The controller/processor 378 could support additional functions as well, such as more advanced wireless communication functions. For instance, the controller/processor 378 could support beam forming or directional routing operations in which outgoing/incoming signals from/to multiple antennas 370a-370n are weighted differently to effectively steer the outgoing signals in a desired direction. Any of a wide variety of other functions could be supported in the gNB 102 by the controller/processor 378.

The controller/processor 378 is also capable of executing programs and other processes resident in the memory 380, such as an OS and, for example, processes to support interleaved DFT phase rotated permutation based FDMA as discussed in greater detail below. The controller/processor 378 can move data into or out of the memory 380 as required by an executing process.

The controller/processor 378 is also coupled to the backhaul or network interface 382. The backhaul or network interface 382 allows the gNB 102 to communicate with other devices or systems over a backhaul connection or over a network. The interface 382 could support communications over any suitable wired or wireless connection(s). For example, when the gNB 102 is implemented as part of a cellular communication system (such as one supporting 5G/NR, LTE, or LTE-A), the interface 382 could allow the gNB 102 to communicate with other gNBs over a wired or wireless backhaul connection. When the gNB 102 is implemented as an access point, the interface 382 could allow the gNB 102 to communicate over a wired or wireless local area network or over a wired or wireless connection to a larger network (such as the Internet). The interface 382 includes any suitable structure supporting communications over a wired or wireless connection, such as an Ethernet or transceiver.

The memory 380 is coupled to the controller/processor 378. Part of the memory 380 could include a RAM, and another part of the memory 380 could include a Flash memory or other ROM.

Although FIG. 3B illustrates one example of gNB 102, various changes may be made to FIG. 3B. For example, the gNB 102 could include any number of each component shown in FIG. 3B. Also, various components in FIG. 3B could be combined, further subdivided, or omitted and additional components could be added according to particular needs.

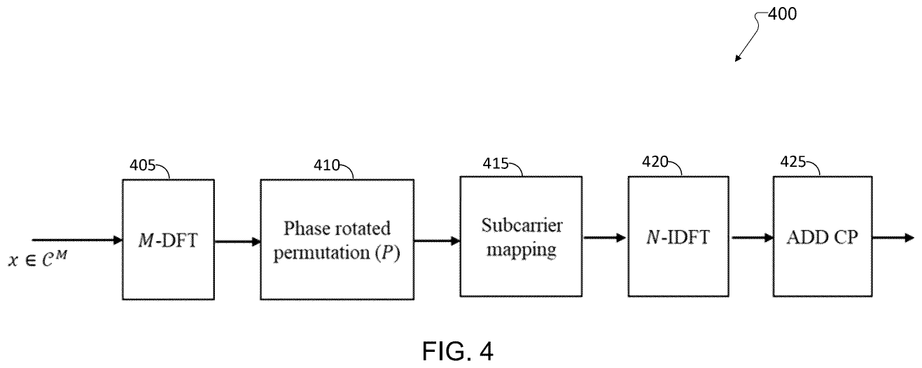

In high mobility scenarios, the fading channel observes Doppler frequency. The Doppler frequency together with multipath fading channels create a doubly selective channel (fading is selective in both time and frequency). A discrete Fourier transform-phase rotated permutation-frequency division multiple access (DFT-p-FDMA) (which may also be referred to as DFT-p-OFDM) waveform, which spreads symbols over a time-frequency 2D grid, is able to deal with such fading channels by exploiting the delay-Doppler diversity. Utilizing a transmitter such as the transmitter shown if FIG. 4, a DFT-p-FDMA waveform can be generated which can perform well in doubly selective channels. The DFT-p-FDMA waveform is based on an OFDM implementation with additional pre-processing that includes DFT and phase rotated permutation, and is based on the principle of discrete affine Fourier transform.

FIG. 4 illustrates an example transmitter 400 according to embodiments of the present disclosure. The embodiment of a transmitter of FIG. 4 is for illustration only. Different embodiments of a transmitter could be used without departing from the scope of this disclosure.

In the example of FIG. 4, it should be understood that in some embodiments, transmitter 400 may be combined with or replace one or more components of transmit path 200 of FIG. 2A in a UE or a gNB. In some embodiments, one or more components of transmitter 400 may be implemented in a processor.

Transmitter 400 includes a discrete Fourier transform (DFT) block 405, a phase rotated permutation block 410, a subcarrier mapping block 415, an inverse discrete Fourier transform (IDFT) block 420, and an add cyclic prefix (CP) block 425.

In transmitter 400, the DFT block 405 receives as input an M length symbol vector x∈ [symbol] ^{M} which is formed using complex symbols. In general, the symbols can be real or imaginary. In some embodiments, the symbols can be generated from binary phase shift keying (BPSK), π/2 BPSK, QPSK or QAM modulation. The DFT block 405 transforms the input into the frequency domain using a DFT operation. The DFT operation may be performed using an M sized FFT, generating a frequency domain M length sequence.

The phase rotated permutation block 410, phase rotates and permutes the output of block 405. The phase rotation has unit magnitude. The phase rotation and permutation operation can be performed via multiplying by an M×M phase rotated permutation matrix P. The matrix P is unitary such that PP^{H}=P^{H}P=I where I is the identity matrix. The matrix P is chosen to satisfy the 2D spreading of the modulation's symbols in time and frequency. These properties allow DFT-p-FDMA to capture the delay-Doppler diversity and results in same effective SINR across modulation symbols at the receiver in doubly selective channels, whereas in CP-OFDM, the modulation symbols undergo different SINR, therefore some modulation symbols are significantly lower SINR over the others.

In some embodiments, the m^{th} row (m∈{0,1, . . . , M−1}) and l^{th} column (l∈{0,1, . . . , M−1}) of the phase rotated permutation matrix P may be given by

$${P}_{m l} = \frac{1}{M √ M} {\sum }_{k = 0}^{M - 1} {\sum }_{n = 0}^{M - 1} exp ( j 2 π ( \frac{- 2 km + {ck}^{2} + 2 nk + {cn}^{2} + 2 nl}{2 M} ) )$$

In these embodiments, the parameter c is chosen such that P is a unitary phase rotated permutation matrix such that in each row and each column, there is only one non-zero element in P and this non-zero element is a unit norm complex exponential. The parameter c defines different realizations of P. In the matrix form, P is given by

$$P = {F}_{M} {Λ}_{c}^{H} {F}_{M}^{H} {Λ}_{c}^{H} {F}_{M}^{H}$$

where the F_{M} denotes the M×M discrete Fourier transform matrix and F_{M}^{H} is the M×M inverse discrete Fourier transform matrix. Further

$${Λ}_{c}^{H}$$

is the Hermitian of Λ_{c}, and Λ_{c} is diagonal matrix such that the m^{th} diagonal element is given by e^{-i2πcm}^{²}/2M where m∈{1, 2, . . . , M}.

The parameter c may satisfy the following conditions such that P is a phase rotated unitary permutation matrix:
The parameter c is an integer
The parameter c is a coprime with M

Once the parameter c is found, the phase rotated permutation matrix P can be obtained.

In some embodiments, the set of c parameters may be found using a non-zero condition. For example, if P is a phase rotated permutation matrix, P can have only one non-zero value in each row and each column.

For any given row m, the Pₘₗ≠0 for only one value of l∈{0 . . . , M−1}. Thus, in order to find the c, any row m∈{0, . . . , M−1} can be chosen and for simplicity, m=0 can be chosen. This approach is detailed as follows:

Find the integer c∈{1,2, . . . ,2M−1} such that Por is non-zero for only one value of l∈{0,1, . . . , M−1} where

$${P}_{0 l} = \frac{1}{M \sqrt{M}} {\sum }_{k = 0}^{M - 1} {\sum }_{n = 0}^{M - 1} exp ( j 2 π ( \frac{{c ( k + n )}^{2} + 2 n ( l + k ( 1 - c ) )}{2 M} ) )$$

In some embodiments, P is designed to be a unitary matrix. In these embodiments, PP^{H}=P^{H}P=I. P satisfies this property when:

$${\sum }_{l = 0}^{M - 1} {\vert {P}_{ml} \vert}^{2} = 1 , ∀ m ∈ \{ 0 , 1 , … , M - 1 \}$$

If P has only one non-zero element in each row, then the absolute value of that element should be equal to 1. However, if it has more than one non-zero elements, then the absolute value of those elements should be less than 1 in order to satisfy the above condition.

Based on the above arguments, the following two methods can be used to find parameter c.
The parameter c can be found such that for any l∈{0,1, . . . , M−1}

$${\vert {P}_{0 l} \vert}^{2} = {\vert \frac{1}{M \sqrt{M}} {\sum }_{k = 0}^{M - 1} {\sum }_{n = 0}^{M - 1} exp ( j 2 π ( \frac{{c ( k + n )}^{2} + 2 n ( l + k ( 1 - c ) )}{2 M} ) ) \vert}^{2} = 1$$

Alternatively, the parameter c can be found using

$${c}^{*} = arg {max}_{c , ∀ l} {\vert {P}_{0 l} \vert}^{2}$$

The search space of c can be reduced by enforcing the following condition:
The parameter c⊂{1, 2, . . . , M−1} and c is a coprime with M.

In some embodiments, the desired values of c are presented for a set of subcarriers M. For example, where a resource block (RB) be defined as 12 subcarriers, M=12×RB.

For these embodiments to function, parameters are configured at both the transmitter and the receiver. Some of these parameters may be specified and some of these parameters may signaled between the transmitter and the receiver. The expression of phase rotated permutation matrix may be specified for a given c and M. In some embodiments, the parameter c values may be specified at the transmitter and the receiver for different values of M. Alternatively, in some embodiments, only a fixed set of parameters c may be specified, (e.g., only two or four values may be specified for a given M). If there are only two choices, then one bit can be used to distinguish two values. As an example, bit 0 may be used to identify the first value of c and bit 1 may be used for a second value of c for a given M. In this example, the bit mapping operation may be denoted by b(c, M).

Once bit mapping and a table of parameter c are specified, the bit sequence b(c, M) can be shared between the transmitter and the receiver through signaling. Then the transmitter and the receiver can obtain the corresponding c value for a respective M. A new field may be created for the bit sequence b(c, M), and in the case of 3GPP specifications, this field can be contained in downlink control information (DCI)/uplink control information (UCI) or other signaling methods such as radio resource control (RRC), or a MAC-CE (Control Element). Then both the transmitter and receiver can use the parameter c to obtain the phase rotated permutation and de-permutation matrices.

Subcarrier mapping block 415 maps the output from block 410 to subcarriers. The subcarrier mapping operation can be performed using a matrix operation, where the input is multiplied by the subcarrier mapping matrix S, where S is a N×M matrix. For each column m E {1, 2, . . . M} of matrix S, there is only one nonzero element, which is equal to one, and located at nₘ such that nₘ≠nₘ for m≠m̅. This way, the m^{th} element of input is mapped to a unique nₘ subcarrier. In some embodiments, the mapping is circularly contiguous such that the mapped subcarrier indexes are L to [L+M−1]_{N} where L∈{0,1,2, . . . N−1} and [·]_{N} denotes the N modulo operation such that [l+N]_{N}=l.

DFT block 420 performs an inverse discrete Fourier transform on the output of block 415. The IDFT operation may be performed using an N sized inverse FFT (IFFT) operation.

Add CP block 425 adds a cyclic prefix to the N length signal output of block 420.

Although FIG. 4 illustrates an example transmitter 400, various changes may be made to FIG. 4. For example, while illustrated with discrete components, the various components of transmitter 400 could be combined into a single component, etc. according to particular needs. Furthermore, while described as being implemented in a transmitter, the operations of the various components of FIG. 4 may be performed by another device, such as a processor. For example, one or more of the operations performed by the components of FIG. 4 could be performed by processor 340 of FIG. 3A, or processor 378 of FIG. 3B.

In practical implementations, channel coding is used for error protection and channel coded bits are spread across multiple waveform symbols (e.g., CP-OFDM or DFT-p-FDMA symbols) through interleaving. This fact allows these waveforms to capture time diversity across multiple symbols. In such situations, modulation symbols of one DFT-p-FDMA symbol have the same SINR. However, across multiple DFT-p-FDMA symbols, the symbols have different block wise SINR. As such some DFT-p-FDMA symbols have lower SINR in comparison to other DFT-p-FDMA symbols. Due to this fact, DFT-p-FDMA is not able to exploit the time diversity across multiple symbols and this impacts performance.

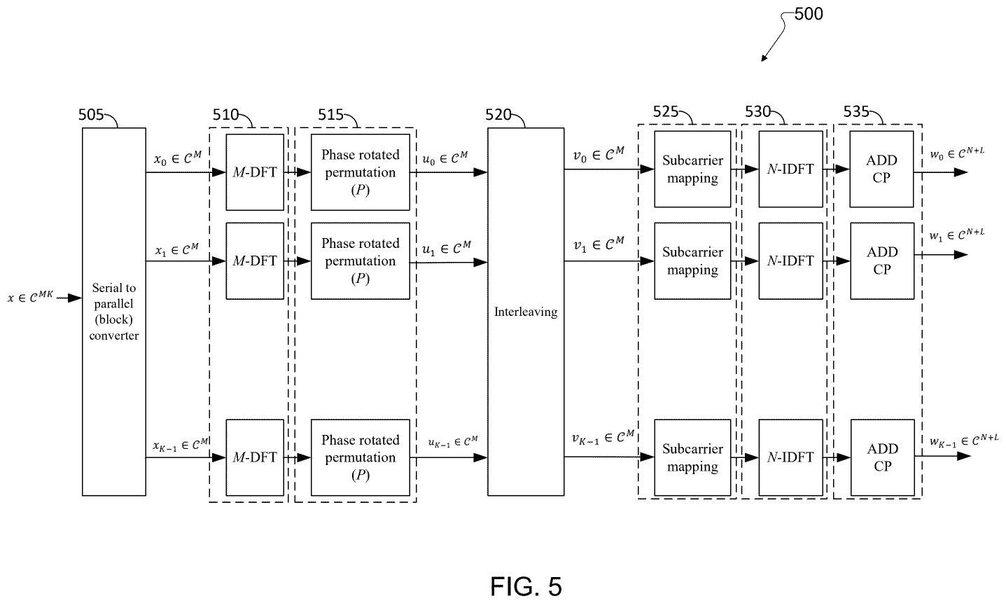

Various embodiments of the present disclosure provide for interleaved DFT-p-FDMA to exploit the time diversity across multiple symbols. As described herein, interleaved DFT-p-FDMA can achieve similar SINR across multiple DFT-p-FDMA symbols, and provide improved link level performance for medium to high mobility scenarios. In some embodiments, such as the transmitter of FIG. 5, a number of interleaved DFT-p-FDMA symbols K are generated from a number of modulation symbols MK.

FIG. 5 illustrates another example transmitter 500 according to embodiments of the present disclosure. The embodiment of a transmitter of FIG. 5 is for illustration only. Different embodiments of a transmitter could be used without departing from the scope of this disclosure.

In the example of FIG. 5, it should be understood that in some embodiments, transmitter 500 may be combined with or replace one or more components of transmit path 200 of FIG. 2A in a UE or a gNB. In some embodiments, one or more components of transmitter 500 may be implemented in a processor.

Transmitter 500 includes a serial to parallel (block) converter 505, K discrete Fourier transform (DFT) blocks 510, K phase rotated permutation blocks 515, an interleaving block 520, K subcarrier mapping blocks 525, K inverse discrete Fourier transform (IDFT) blocks 530, and K add cyclic prefix (CP) blocks 535.

In transmitter 500, the serial to parallel (block) converter 505 receives as input an MK length modulation symbol sequence x∈ [symbol] ^{MK}. The MK modulation symbols, can be generated from BPSK,

$$\frac{π}{2} BPSK ,$$

QPSK or any other QAM modulation. Additionally, the MK modulation symbols can be generated from any other constellations, and they are complex in general. However, the MK modulation symbols can be either real or imaginary.

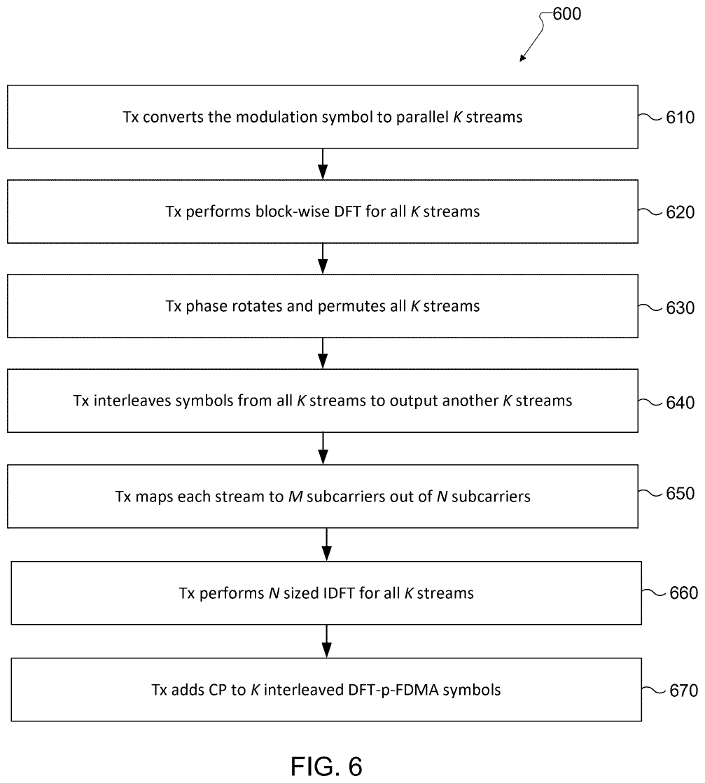

Serial to parallel (block) converter 505 converts the MK length modulation symbol sequence into K streams of M length modulation symbol sequences, similar as described regarding operation 610 of FIG. 6. These K sequences are denoted by x₀, x₁, . . . , x_{K-1}. Each of the DFT blocks 510 transforms one of the K sequences into the frequency domain using a DFT operation, similar as described regarding operation 620 of FIG. 6. Each of the phase rotated permutation blocks 615 phase rotates and permutes the output of one of the blocks 605, which creates K streams of the intermediate symbols denoted by u₀, u₁, . . . , u_{K-1}, where each stream is of length M, similar as described regarding operation 630 of FIG. 6. Interleaving block 520 interleaves the elements of u₀, u₁, . . . , u_{K-1} to obtain K streams of sequences v₀, v₁, . . . , v_{K-1} such that vₖ ∇k∈{0,1, . . . , K−1} is of length M, similar as described regarding operation 640 of FIG. 6. Each of the subcarrier mapping blocks 525 maps one of the vₖ ∇k∈{0,1, . . . , K−1} interleaved sequences to subcarriers, similar as described regarding operation 650 of FIG. 6. Each of the IDFT blocks 530 performs an inverse discrete Fourier transform on the output of one of blocks 525, similar as described regarding operation 660 of FIG. 6. Each of the add CP blocks 535 adds a cyclic prefix to the output of one of the blocks 530, similar as described regarding operation 670 of FIG. 6.

Although FIG. 5 illustrates an example transmitter 500, various changes may be made to FIG. 5. For example, while illustrated with discrete components, the various components of transmitter 500 could be combined into a single component, etc. according to particular needs. Furthermore, while described as being implemented in a transmitter, the operations of the various components of FIG. 5 may be performed by another device, such as a processor. For example, one or more of the operations performed by the components of FIG. 5 could be performed by processor 340 of FIG. 3A, or processor 378 of FIG. 3B.

FIG. 6 illustrates an example procedure 600 for operation of a transmitter according to embodiments of the present disclosure. An embodiment of the procedure illustrated in FIG. 6 is for illustration only. One or more of the components illustrated in FIG. 6 may be implemented in specialized circuitry configured to perform the noted functions or one or more of the components may be implemented by one or more processors executing instructions to perform the noted functions. Other embodiments of a procedure for operation of a transmitter could be used without departing from the scope of this disclosure.

In the example of FIG. 6, procedure 600 for operation of a transmitter (such as transmitter 500 of FIG. 5) begins at operation 610. At operation 610, the input (e.g., an MK length modulation symbol sequence x∈ [symbol] ^{MK}) is converted (e.g., by block 505 of transmitter 500) into K streams of M length of modulation symbol sequences. These K sequences are denoted by x₀, x₁, . . . , x_{K-1} as shown in FIG. 5.

At operation 620, each M length stream is transformed (e.g., by one of the blocks 510 of transmitter 500) using an M sized DFT. Each of the transformations may be performed in parallel.

At operation 630, K sequences are phase rotated and permuted (e.g., by one of the blocks 515 of transmitter 500). Each of the phase rotations and permutations may be performed in parallel. Each phase rotation may have unit magnitude. The phase rotation and permutation operation for each sequence can be performed via multiplying by M×M phase rotated permutation matrix P. The matrix P is unitary such that PP^{H}=P^{H}P=I where I is the identity matrix. The output of operation 630 creates K streams of the intermediate symbols denoted by u₀, u₁, . . . , u_{K-1} as shown in FIG. 5, where each stream is of length M. In some embodiments, operation 630 may performed based on one or more parameters c as described herein.

At operation 640, the elements of u₀, u₁, . . . , u_{K-1} may be interleaved (e.g., by block 520 of transmitter 500) to obtain K streams of sequences v₀, v₁, . . . , v_{K-1} such that vₖ ∇k∈{0,1, . . . , K−1} is of length M. In some embodiments, the interleaving function is defined as follows for the m^{th} element of vₖ

$${v}_{k} ( m ) = {u}_{{\prod }_{1} ( k , m )} ( {\prod }_{2} ( k , m ) )$$

where ┌₁(k,m) and Π₂(k, m) defines the interleaving function.

At operation 650, each interleaved sequence vₖ ∇k∈{0,1, . . . , K−1} is mapped (e.g., by one of the blocks 525 of transmitter 500) to M subcarriers. The mapping of the interleaved sequences may be performed in parallel. In some embodiments, the mapping may be circularly contiguous.

At the operation 660, an N sized inverse discrete Fourier transform is performed (e.g., by one of the blocks 530 of transmitter 500) for all K streams to obtain K interleaved DFT-p-FDMA symbols. Each of the IDFT operations may be performed in parallel.

At the operation 670, a cyclic prefix may be added (e.g., by one of the blocks 535 of transmitter 500) to each of the interleaved DFT-p-FDMA symbols.

Although FIG. 5 illustrates one example procedure 500 for operation of a transmitter, various changes may be made to FIG. 5. For example, while shown as a series of operations, various operations in FIG. 5 could overlap, occur in parallel, occur in a different order, occur any number of times, be omitted, or replaced by other operations.

In some embodiments, a different interleaving function may be used to generate interleaved DFT-p-FDMA symbols than the interleaving function described regarding operation 640 of FIG. 6. For example, in some embodiments, an interleaving function may interleave the elements of u₀, u₁, . . . , u_{K-1} to find the v₀, v₁, . . . , v_{K-1} as follows:

Let the MK length sequence q be defined as

$$q = [ {u}_{0} ( 0 ) {u}_{1} ( 0 ) … {u}_{K - 1} ( 0 ) {u}_{0} ( 1 ) {u}_{1} ( 1 ) … {u}_{K - 1} ( 1 ) … {u}_{0} ( M - 1 ) {u}_{1} ( M - 1 ) … {u}_{K - 1} ( M - 1 ) ]$$

$${m}^{′} = ⌊ \frac{r}{K} ⌋$$

Such that the q(r)=u_{k′}(m′) where k′=[r]_{K} and [r]_{K} denotes the r modulo K and where └·┘ denotes the floor operation that gives the largest integer smaller than the argument value. The resultant vₖ(m)∀k∈{0,1, . . . , K−1} and m∈{0,1, . . . , M−1} is given by

$${v}_{k} ( m ) = q ( kM + m )$$

The direct relationship, vₖ(m) is

$${v}_{k} ( m ) = {u}_{{[ kM + m ]}_{K}} ( ⌊ \frac{kM + m}{K} ⌋ )$$

As such vₖ(m)=u_{Π}_{₁}(k,m)(Π₂(k, m)), and the interleaving functions Π₁(k,m) and Π₂(k, m) are defined by

$${\prod }_{1} ( k , m ) = {[ kM + m ]}_{K}$$

$${\prod }_{2} ( k , m ) = ⌊ \frac{kM + m}{K} ⌋$$

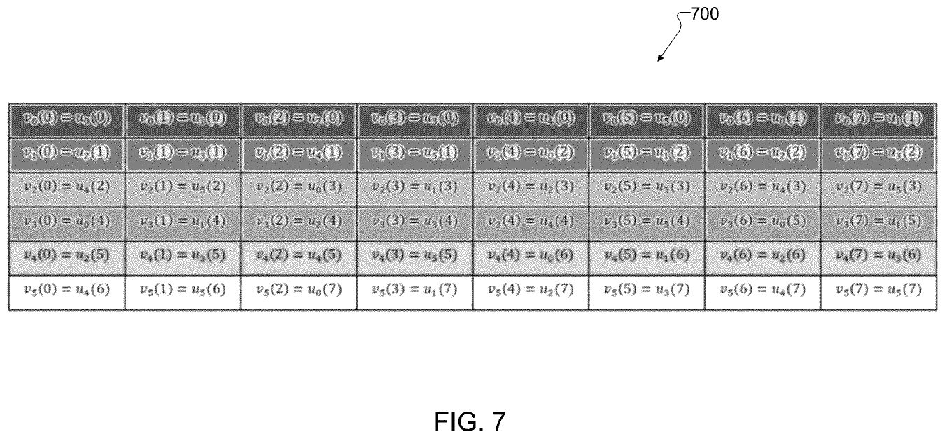

An example of interleaving according to this interleaving function is shown in FIG. 7 for M=8 and K=6.

FIG. 7 illustrates an example of interleaving 700 according to embodiments of the present disclosure. The embodiment of interleaving of FIG. 7 is for illustration only. Different embodiments of interleaving could be used without departing from the scope of this disclosure.

In the example of FIG. 7, the k^{th} and m^{th} elements of vₖ(m) are shown in columns and rows respectively for M=8 and K=6. Different shading is used to denote the vₖ vectors.

Although FIG. 7 illustrates one example of interleaving 700, various changes may be made to FIG. 7. For instance, the example of FIG. 7 can be generalized into any M and K.

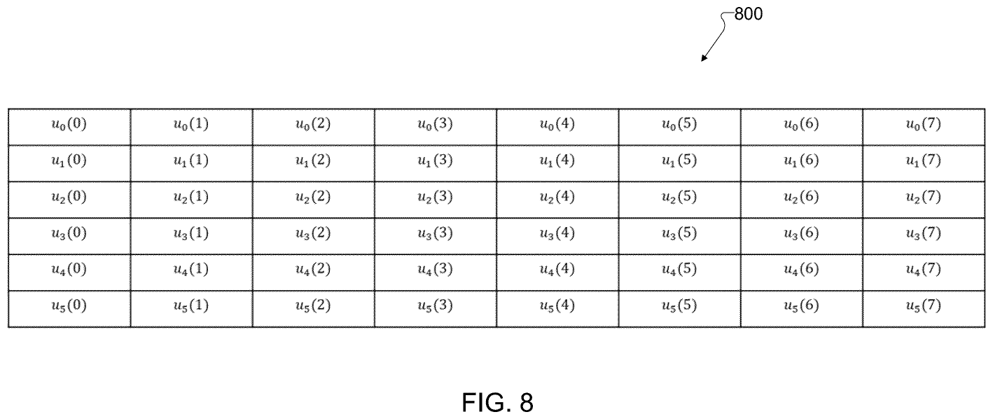

This interleaving procedure can be considered as placing the uₖ elements as consecutive row vectors and obtaining the vₖ elements through the columns. This can be explained as follows. Let the k^{th} row be allocated to elements of uₖ as shown in FIG. 8.

FIG. 8 illustrates an example of row allocation 800 according to embodiments of the present disclosure. The embodiment of row allocation of FIG. 8 is for illustration only. Different embodiments of row allocation could be used without departing from the scope of this disclosure. Although FIG. 8 illustrates one example of row allocation 800, various changes may be made to FIG. 8. For instance, the example of FIG. 8 can be generalized into any M and K.

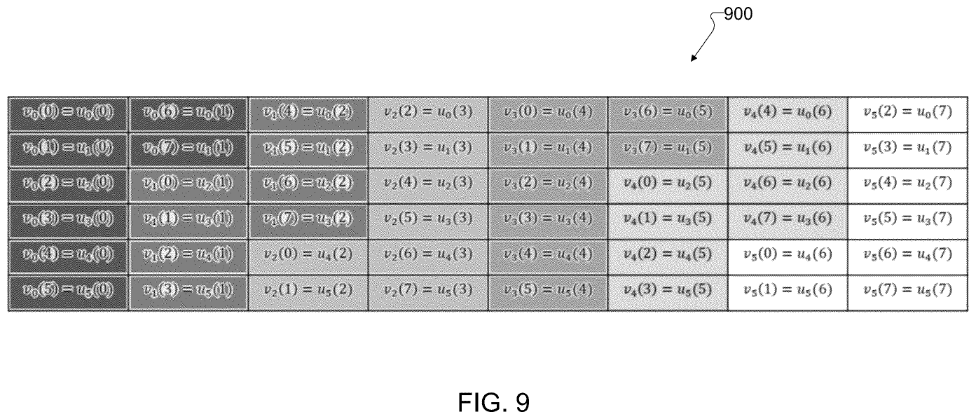

Now the elements of vₖ are read through the columns as shown in FIG. 9.

FIG. 9 illustrates an example interleaving operation 900 according to embodiments of the present disclosure. The embodiment of an interleaving operation of FIG. 9 is for illustration only. Different embodiments of an interleaving operation could be used without departing from the scope of this disclosure.

In the example of FIG. 9, the interleaving operation is for M=8 and K=6. Different shading is used to denote the vₖ vectors.

Although FIG. 9 illustrates one example interleaving operation 900, various changes may be made to FIG. 9. For instance, the example of FIG. 9 can be generalized into any M and K.

In some embodiments, an interleaving function may interleave the elements of u₀, u₁, . . . , u_{K-1} to find the v₀, v₁, . . . , v_{K-1} as follows:

Let the r^{th} element of the MK length sequence p be defined as p(r)=u_{k′}(m′) where k′=[r]_{K} and

$${m}^{′} = {[ ⌊ \frac{r}{K} ⌋ + {[ r ]}_{K} ]}_{M} .$$

The resultant vₖ(m)∀k∈{0,1, . . . , K−1} and m∈{0,1, . . . , M−1} is given by

$${v}_{k} ( m ) = p ( kM + m )$$

The direct relationship, vₖ(m) is

$${v}_{k} ( m ) = {u}_{{[ kM + m ]}_{K}} ( {[ ⌊ \frac{kM + m}{K} ⌋ + {[ kM + m ]}_{K} ]}_{M} )$$

As such vₖ(m)=u_{Π}_{₁}_{(k,m)}(Π₂(k, m)), and the interleaving functions Π₁(k, m) and Π₂(k, m) are defined as

$${\prod }_{1} ( k , m ) = {[ kM + m ]}_{K}$$

$${\prod }_{2} ( k , m ) = {[ ⌊ \frac{k M + m}{K} ⌋ + {[ kM + m ]}_{K} ]}_{M}$$

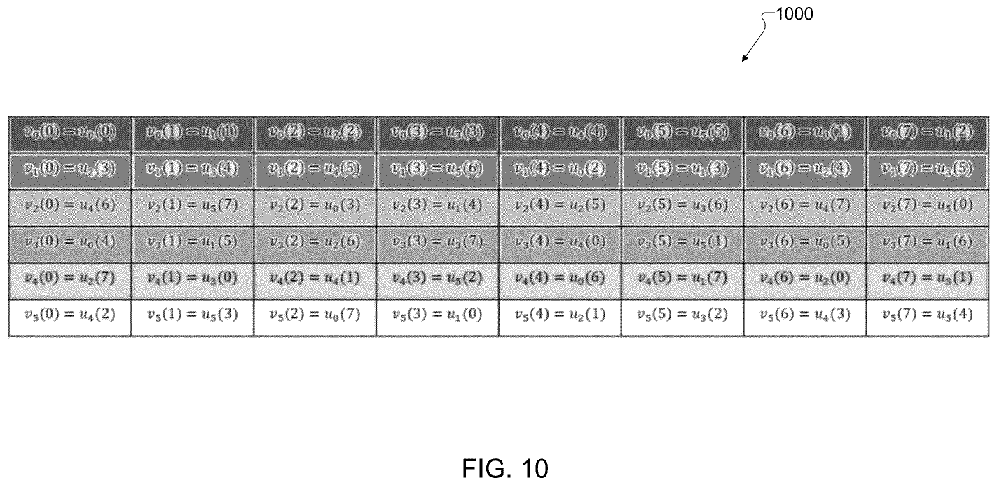

An example of interleaving according to this interleaving function is shown in FIG. 10 for M=8 and K=6.

FIG. 10 illustrates another example of interleaving 1000 according to embodiments of the present disclosure. The embodiment of interleaving of FIG. 10 is for illustration only. Different embodiments of interleaving could be used without departing from the scope of this disclosure.

In the example of FIG. 10, the k^{th} and m^{th} elements of vₖ(m) are shown in columns and rows respectively for M=8 and K=6. Different shading is used to denote the vₖ vectors.

Although FIG. 10 illustrates one example of interleaving 1000, various changes may be made to FIG. 10. For instance, the example of FIG. 10 can be generalized into any M and K.

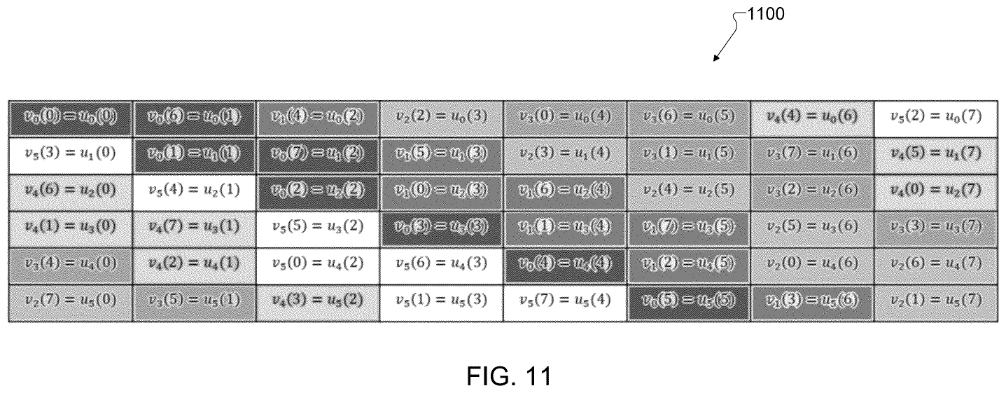

This interleaving procedure can be considered as placing the uₖ as consecutive row vectors, and obtaining the vₖ diagonally as shown in FIG. 11. Note that the k^{th} row is allocated to elements of uₖ.

FIG. 11 illustrates another example interleaving operation 1100 according to embodiments of the present disclosure. The embodiment of an interleaving operation of FIG. 11 is for illustration only. Different embodiments of an interleaving operation could be used without departing from the scope of this disclosure.

In the example of FIG. 11, the interleaving operation is for M=8 and K=6. Different shading is used to denote the vₖ vectors.

Although FIG. 11 illustrates one example interleaving operation 1100, various changes may be made to FIG. 11. For instance, the example of FIG. 11 can be generalized into any M and K.

In some embodiments, certain parameters and procedures may be specified at the transmitter and the receiver for interleaved DFT-p-FDMA to operate. These may include:
Procedure to interpolate.
Interpolating functions.
Number of symbols M to be interpolated.

In some embodiments, additional signaling parameters may be used for both non-interleaved and interleaved DFT-p-FDMA to operate. This can be executed using one bit b₁ where one value of b₁ (either 0 or 1) indicates non-interleaved DFT-p-FDMA and the other value indicates interleaved DFT-p-FDMA. For an example this assignment is shown in Table 1.

TABLE 1
Bit assignment for non-interleaved and interleaved DFT-p-FDMA

| b₁ | Operation |
|---|---|
| 0 | Non-interleaved DFT-p-FDMA |
| 1 | Interleaved DFT-p-FDMA |

If more than one interpolation function is specified, then additional signaling maybe used to choose one interpolation function over the other. This can be performed using a bit sequence b₂ where bit patterns are assigned to distinct interpolating functions. An example is shown in Table 2.

TABLE 2
Bit assignment for different interpolating functions

| | Interpolation |
|---|---|
| b₂ | function |
| 00 | Function #1 |
| 01 | Function #2 |
| 10 | Function #3 |
| 11 | Function #4 |

Note that while Table 2 includes four functions assigned by two bits for bit sequence b₂, bit sequence b₂ may include fewer or additional bits as needed to support any number of interpolating functions.

In some embodiments where the number of symbols M is not specified for interleaving, then this parameter can be signaled for interleaved DFT-p-FDMA to operate.

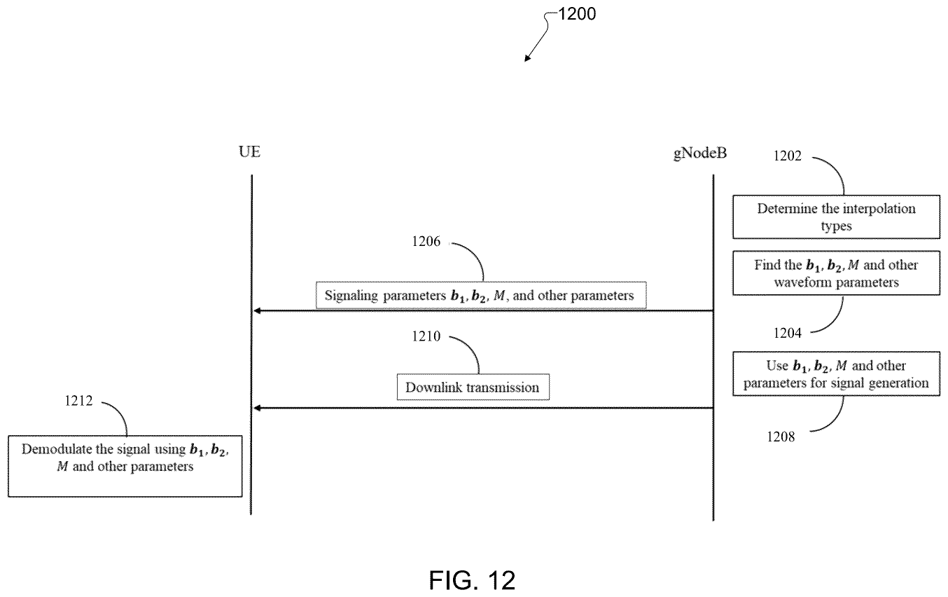

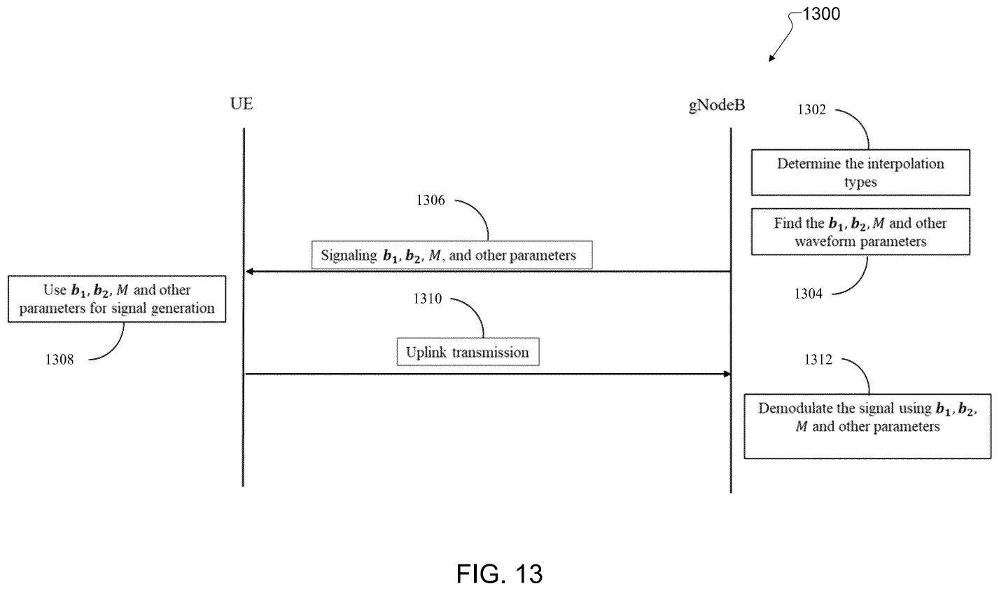

In some embodiments, a new field may be created for the bit sequence b₁, b₂ and M. In the case of 3GPP specifications, this field can be contained in downlink control information (DCI)/uplink control information (UCI) or other signaling methods such as radio resource control (RRC), or a MAC-CE (Control Element). In some embodiments, the signaling may be as shown in FIG. 12 and/or FIG. 13.

FIG. 12 illustrates an example procedure 1200 for downlink signaling according to embodiments of the present disclosure. An embodiment of the procedure illustrated in FIG. 12 is for illustration only. One or more of the components illustrated in FIG. 12 may be implemented in specialized circuitry configured to perform the noted functions or one or more of the components may be implemented by one or more processors executing instructions to perform the noted functions. Other embodiments for downlink signaling could be used without departing from the scope of this disclosure.

In the example of FIG. 12, a gNB (such as BS 102 of FIG. 1) is operating as a transmitter in the downlink, and a UE (such as UE 116 of FIG. 1) is operating as a receiver.

Procedure 1200 begins at operation 1202. At operation 1202, the gNB determines the parameters related to the waveform. These may include the allocated bandwidth, MCS, and parameters related to DFT-p-FDMA (e.g., c).

At operation 1204, the gNB chooses the parameters related to interleaving, which are b₁ and b₂. Further, if M is not specified, then M is also selected.

Then at operation 1206, the gNB signals the parameters selected at operations 1202 and 1204 to the UE.

At operation 1208, the gNB generates the signal based on the specified procedures and parameters selected at operations 1202 and 1204.

At operation 1210, the gNB transmits the signal to the UE.

At operation 1212, the UE uses the specified parameters and procedures together with the parameters received at operation 1206 to demodulate the signal.

Although FIG. 12 illustrates one example procedure 1200 for downlink signaling, various changes may be made to FIG. 12. For example, while shown as a series of operations, various operations in FIG. 12 could overlap, occur in parallel, occur in a different order, occur any number of times, be omitted, or replaced by other operations.

FIG. 13 illustrates an example procedure 1300 for uplink signaling according to embodiments of the present disclosure. An embodiment of the procedure illustrated in FIG. 13 is for illustration only. One or more of the components illustrated in FIG. 13 may be implemented in specialized circuitry configured to perform the noted functions or one or more of the components may be implemented by one or more processors executing instructions to perform the noted functions. Other embodiments of a procedure for uplink signaling could be used without departing from the scope of this disclosure.

In the example of FIG. 13, a gNB (such as BS 102 of FIG. 1) is operating as a receiver in the uplink, and a UE (such as UE 116 of FIG. 1) is operating as a transmitter.

Procedure 1300 begins at operation 1302. At operation 1302, the gNB determines the parameters related to the waveform. These may include the allocated bandwidth, MCS, and parameters related to DFT-p-FDMA (e.g., c).

At operation 1304, the gNB chooses the parameters related to interleaving, which are b₁ and b₂. Further, if M is not specified, then M is also selected.

At operation 1306, the gNB signals the parameters selected at operations 1302 and 1304 to the UE.

At operation 1308, the UE generates the signal based on the specified procedures/parameters and the parameters received at operation 1306.

At operation 1310, the UE transmits the signal to the gNB.

At operation 1312, the gNB uses the specified parameters and procedures together with the parameters selected at operations 1302 and 1304 to demodulate the signal.

Although FIG. 13 illustrates one example procedure 1300 for uplink signaling, various changes may be made to FIG. 13. For example, while shown as a series of operations, various operations in FIG. 13 could overlap, occur in parallel, occur in a different order, occur any number of times, be omitted, or replaced by other operations.

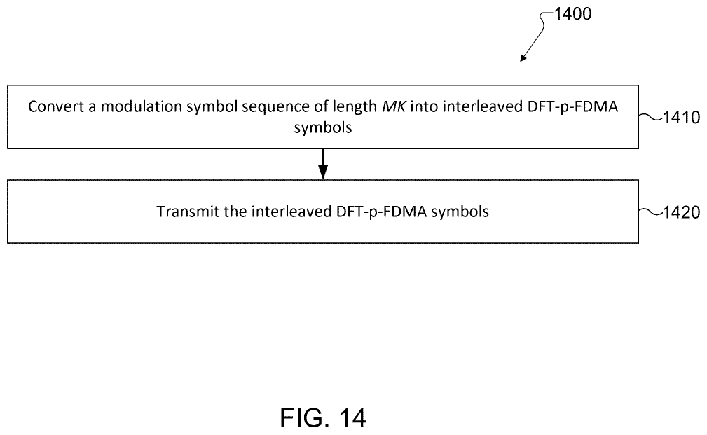

FIG. 14 illustrates an example method for interleaved DFT phase rotated permutation based FDMA 1400 according to embodiments of the present disclosure. An embodiment of the method illustrated in FIG. 14 is for illustration only. One or more of the components illustrated in FIG. 14 may be implemented in specialized circuitry configured to perform the noted functions or one or more of the components may be implemented by one or more processors executing instructions to perform the noted functions. Other embodiments of a method for interleaved DFT phase rotated permutation based FDMA could be used without departing from the scope of this disclosure.

In the example of FIG. 14, method 1400 begins at operation 1410. At operation 1410, an electronic device (such as UE 116 or BS 102 of FIG. 1) converts a modulation symbol sequence of length MK into interleaved DFT-p-FDMA symbols. For example, the electronic device may convert the modulation symbol sequence utilizing a transmitter such as transmitter 500 FIG. 5 according to procedure 600 of FIG. 6.

In some embodiments, to convert the modulation symbol sequence into interleaved DFT-p-FDMA symbols, the electronic device may: convert the modulation symbol sequence into K parallel streams of modulation symbols; transform each of the parallel streams with a block-wise DFT; phase rotate and permute each of the transformed parallel streams of modulation symbols; interleave the phase rotated and permuted parallel streams of modulation symbols, to generate interleaved sequences; map each of the interleaved sequences to subcarriers; transform each of the mapped sequences with an IFFT, to generate the interleaved DFT-p-FDMA symbols; and add a cyclic prefix (CP) to the interleaved DFT-p-FDMA symbols.

In some embodiments, to interleave the phase rotated and permuted parallel streams, the electronic device may define an interleaving function, wherein an M^{th} element of a K^{th} interleaved sequence is determined by a modulo operation on an original sequence and a floor operation to distribute the elements across the interleaved sequences.

In some embodiments, the electronic device may be a UE, and the UE may receive, from a BS, parameters indicating whether interleaving is applied to transmitted symbols. In response to the parameters indicating that interleaving is applied to transmitted symbols, the UE may convert the modulation symbol sequence into the interleaved DFT-p-FDMA symbols. In some embodiments, the parameters may further indicate an interleaving function and a number of symbols to be interleaved, and the UE may convert the modulation symbol sequence into the interleaved DFT-p-FDMA symbols based on the interleaving function and the number of symbols to be interleaved.

At operation 1420, the electronic device transmits the interleaved DFT-p-FDMA symbols.

In some embodiments, the electronic device may be a UE, and the UE may receive, from a BS, parameters indicating whether interleaving is applied to DFT-p-FDMA symbols in a downlink transmission. The UE may also receive, from the BS, the downlink transmission, and demodulate the downlink transmission based on the parameters indicating whether interleaving is applied to DFT-p-FDMA symbols in downlink transmission. In some embodiments, the parameters may further indicate an interleaving function and a number of symbols to be interleaved, and the UE may demodulate the downlink transmission based on the interleaving function and the number of symbols to be interleaved.

Although FIG. 14 illustrates one example method for interleaved DFT phase rotated permutation based FDMA 1400, various changes may be made to FIG. 14. For example, while shown as a series of operations, various operations in FIG. 14 could overlap, occur in parallel, occur in a different order, occur any number of times, be omitted, or replaced by other operations.

Any of the above variation embodiments can be utilized independently or in combination with at least one other variation embodiment. The above flowcharts illustrate example methods that can be implemented in accordance with the principles of the present disclosure and various changes could be made to the methods illustrated in the flowcharts herein. For example, while shown as a series of operations, various operations in each figure could overlap, occur in parallel, occur in a different order, or occur multiple times. In another example, operations may be omitted or replaced by other operations.

Although the present disclosure has been described with exemplary embodiments, various changes and modifications may be suggested to one skilled in the art. It is intended that the present disclosure encompass such changes and modifications as fall within the scope of the appended claims. None of the description in this application should be read as implying that any particular element, operation, or function is an essential element that must be included in the claim scope. The scope of patented subject matter is defined by the claims.

What is claimed is:

1. An electronic device comprising:
a processor configured to convert a modulation symbol sequence of length MK into interleaved discrete Fourier transform phase rotated permutation based frequency division multiple access (DFT-p-FDMA) symbols; and
a transceiver operatively coupled to the processor, the transceiver configured to transmit the interleaved DFT-p-FDMA symbols.

2. The electronic device of claim 1, wherein to convert the modulation symbol sequence into interleaved DFT-p-FDMA symbols, the processor is further configured to:
convert the modulation symbol sequence into K parallel streams of modulation symbols;
transform each of the parallel streams with a block-wise discrete Fourier transform (DFT);
phase rotate and permute each of the transformed parallel streams of modulation symbols;
interleave the phase rotated and permuted parallel streams of modulation symbols, to generate interleaved sequences;
map each of the interleaved sequences to subcarriers;
transform each of the mapped sequences with an inverse fast Fourier transform (IFFT), to generate the interleaved DFT-p-FDMA symbols; and
add a cyclic prefix (CP) to the interleaved DFT-p-FDMA symbols.

3. The electronic device of claim 2, wherein to interleave the phase rotated and permuted parallel streams, the processor is further configured to define an interleaving function, wherein an M^{th} element of a K^{th} interleaved sequence is determined by a modulo operation on an original sequence and a floor operation to distribute elements across the interleaved sequences.

4. The electronic device of claim 1, wherein:
the electronic device is a user equipment;
the transceiver is further configured to receive, from a base station (BS), parameters indicating whether interleaving is applied to transmitted symbols; and
the processor is configured to, in response to the parameters indicating that interleaving is applied to transmitted symbols, convert the modulation symbol sequence into the interleaved DFT-p-FDMA symbols.

5. The electronic device of claim 4, wherein:
the parameters further indicate an interleaving function and a number of symbols to be interleaved; and
the processor is configured to convert the modulation symbol sequence into the interleaved DFT-p-FDMA symbols based on the interleaving function and the number of symbols to be interleaved.

6. The electronic device of claim 1, wherein:
the electronic device is a user equipment;
the transceiver is further configured to:
receive, from a base station (BS), parameters indicating whether interleaving is applied to DFT-p-FDMA symbols in a downlink transmission; and
receive, from the BS, the downlink transmission; and
the processor is configured to demodulate the downlink transmission based on the parameters indicating whether interleaving is applied to DFT-p-FDMA symbols in downlink transmission.

7. The electronic device of claim 6, wherein:
the parameters further indicate an interleaving function and a number of symbols to be interleaved; and
the processor is configured to demodulate the downlink transmission based on the interleaving function and the number of symbols to be interleaved.

8. A method of operating an electronic device, the method comprising:
converting a modulation symbol sequence of length MK into interleaved discrete Fourier transform phase rotated permutation based frequency division multiple access (DFT-p-FDMA) symbols; and
transmitting the interleaved DFT-p-FDMA symbols.

9. The method of claim 8, wherein to convert the modulation symbol sequence into interleaved DFT-p-FDMA symbols, the method further comprises:
converting the modulation symbol sequence into K parallel streams of modulation symbols;
transforming each of the parallel streams with a block-wise discrete Fourier transform (DFT);
phase rotating and permuting each of the transformed parallel streams of modulation symbols;
interleaving the phase rotated and permuted parallel streams of modulation symbols, to generate interleaved sequences;
mapping each of the interleaved sequences to subcarriers;
transforming each of the mapped sequences with an inverse fast Fourier transform (IFFT), to generate the interleaved DFT-p-FDMA symbols; and
adding a cyclic prefix (CP) to the interleaved DFT-p-FDMA symbols.

10. The method of claim 9, wherein to interleave the phase rotated and permuted parallel streams, the method further comprises defining an interleaving function, wherein an M^{th} element of a K^{th} interleaved sequence is determined by a modulo operation on an original sequence and a floor operation to distribute elements across the interleaved sequences.

11. The method of claim 8, wherein:
the electronic device is a user equipment; and
the method further comprises:
receiving, from a base station (BS), parameters indicating whether interleaving is applied to transmitted symbols; and
in response to the parameters indicating that interleaving is applied to transmitted symbols, converting the modulation symbol sequence into the interleaved DFT-p-FDMA symbols.

12. The method of claim 11, wherein:
the parameters further indicate an interleaving function and a number of symbols to be interleaved; and
the method further comprises converting the modulation symbol sequence into the interleaved DFT-p-FDMA symbols based on the interleaving function and the number of symbols to be interleaved.

13. The method of claim 8, wherein:
the electronic device is a user equipment; and
the method further comprises:
receiving, from a base station (BS), parameters indicating whether interleaving is applied to DFT-p-FDMA symbols in a downlink transmission;
receiving, from the BS, the downlink transmission; and
demodulating the downlink transmission based on the parameters indicating whether interleaving is applied to DFT-p-FDMA symbols in downlink transmission.

14. The method of claim 13, wherein:
the parameters further indicate an interleaving function and a number of symbols to be interleaved; and
the method further comprises demodulating the downlink transmission based on the interleaving function and the number of symbols to be interleaved.

15. A non-transitory computer readable medium embodying program code, the computer program comprising program code that, when executed by a processor of a device, causes the device to:
convert a modulation symbol sequence of length MK into interleaved discrete Fourier transform phase rotated permutation based frequency division multiple access (DFT-p-FDMA) symbols; and
transmit the interleaved DFT-p-FDMA symbols.

16. The non-transitory computer readable medium of claim 15, wherein to convert the modulation symbol sequence into interleaved DFT-p-FDMA symbols, the computer program further comprises program code that, when executed by the processor, causes the device to:
convert the modulation symbol sequence into K parallel streams of modulation symbols;
transform each of the parallel streams with a block-wise discrete Fourier transform (DFT);
phase rotate and permute each of the transformed parallel streams of modulation symbols;
interleave the phase rotated and permuted parallel streams of modulation symbols, to generate interleaved sequences;
map each of the interleaved sequences to subcarriers;
transform each of the mapped sequences with an inverse fast Fourier transform (IFFT), to generate the interleaved DFT-p-FDMA symbols; and
add a cyclic prefix (CP) to the interleaved DFT-p-FDMA symbols.

17. The non-transitory computer readable medium of claim 16, wherein to interleave the phase rotated and permuted parallel streams, the computer program further comprises program code that, when executed by the processor, causes the device to define an interleaving function, wherein an M^{th} element of a K^{th} interleaved sequence is determined by a modulo operation on an original sequence and a floor operation to distribute elements across the interleaved sequences.

18. The non-transitory computer readable medium of claim 15, wherein:
the device is a user equipment; and
the computer program further comprises program code that, when executed by the processor, causes the device to:
receive, from a base station (BS), parameters indicating whether interleaving is applied to transmitted symbols; and
in response to the parameters indicating that interleaving is applied to transmitted symbols, convert the modulation symbol sequence into the interleaved DFT-p-FDMA symbols.

19. The non-transitory computer readable medium of claim 18, wherein:
the parameters further indicate an interleaving function and a number of symbols to be interleaved; and
the computer program further comprises program code that, when executed by the processor, causes the device to convert the modulation symbol sequence into the interleaved DFT-p-FDMA symbols based on the interleaving function and the number of symbols to be interleaved.

20. The non-transitory computer readable medium of claim 15, wherein:
the device is a user equipment; and
the computer program further comprises program code that, when executed by the processor, causes the device to:
receive, from a base station (BS), parameters indicating whether interleaving is applied to DFT-p-FDMA symbols in a downlink transmission, an interleaving function, and a number of symbols to be interleaved;
receiving, from the BS, the downlink transmission; and
demodulate the downlink transmission based on the parameters indicating whether interleaving is applied to DFT-p-FDMA symbols in downlink transmission, the interleaving function, and the number of symbols to be interleaved.
